(19) United States
(12) Patent Application Publication
(10) Pub. No.: US 2014/0103086 A1
(43) Pub. Date: Apr. 17, 2014

(54) Shopping List Attachment and Holder for a Shopping Cart

(71) Applicant: Michael Olivieri, Lagrangeville, NY (US)

(72) Inventor: Michael Olivieri, Lagrangeville, NY (US)

(21) Appl. No.: 13/918,950

(22) Filed: Jun. 15, 2013

Related U.S. Application Data
(60) Provisional application No. 61/712,727, filed on Oct. 11, 2012.

(51) Int. Cl. B62B 5/00

(52) U.S. Cl. CPC B62B 5/00
USPC 224/411

(57) ABSTRACT

A shopping cart list holder includes a central list backing support, a support neck, and a cart attachment. The list holder is adapted so that it is easy to attach to a shopping basket or shopping cart. The list holder is designed to hold one or more pieces of paper to the backing support so that the user does not have to fumble between his pockets and the shopping cart or basket for his shopping list. The list holder may also include holders for pens, water bottles, or cell phones.

### CROSS REFERENCE TO RELATED APPLICATIONS

The present application claims benefit to U.S. provisional application No. 61/712727 titled “Shopping List Attachment and Holder for a Shopping Cart or Basket” with Michael Olivieri as the sole inventor, which is incorporated herein by reference.

### FIELD OF THE INVENTION

The field of the present invention generally relates to attachments and accessories for shopping carts and baskets of all shapes and sizes.

### BACKGROUND OF THE INVENTION

People regularly use shopping carts or shopping baskets when shopping at stores. Shopping baskets and carts make it easier to store items while continuing shopping. People also rely on shopping lists when shopping. While these lists are useful, they can often get in the way during the shopping experience. Customers need to use at least one hand for the shopping basket or cart and at least one hand to retrieve items from the counters and shelves of the store. This means that a customer is likely to place the shopping list in his pockets or wallet where he cannot readily refer to it or place it in the shopping cart or basket where it might get lost among the merchandise.

What is needed is a way to revolutionize the shopping experience so that shoppers do not have to look down at lists and reach in their pockets repeatedly causing them frustration, bumping carts, passing friends, and missing valuable shopping time.

What is needed is a smarter way to shop. Retailers will enjoy providing additional customer value and satisfaction while manufactures will enjoy providing retailers with this value-adding accessory.

### SUMMARY OF THE INVENTION

This summary is provided to introduce (in a simplified form) a selection of concepts that are further described below in the Detailed Description. This summary is not intended to identify key features of the claimed subject matter, nor is it intended to be used as an aid in determining the scope of the claimed subject matter.

In overcoming the above disadvantages associated with the use of shopping lists with shopping carts or baskets, a shopping cart list holder is introduced. The shopping cart list holder is an attachment designed to be connected to any shopping cart or shopping basket and can hold the customer's shopping list. The list holder keeps the shopping list within the eyesight of the customer without requiring him to hold it, thus freeing up his hands for controlling the cart or basket and reaching to select merchandise from the aisles. The shopping cart list holder may use a variety of ways to secure the shopping list to the list holder. These include but are not limited to a clip or set of clips, flaps, sleeves, or adhesives, or any combination thereof. The list holder may optionally include additional holders for water bottles or cell phones or other devices commonly referred to or used during shopping. The shopping list is light and compact, weighing less than a pound and with a height and width measured in inches.

### BRIEF DESCRIPTION OF THE DRAWINGS

Preferred and alternative examples of the present invention are described in detail below with reference to the following Figure drawings:

FIG. 1 illustrates a shopping cart list holder in accordance with the present invention;

FIG. 2 illustrates a shopping cart list holder with additional capacity in accordance with the present invention;

FIG. 3 illustrates a shopping cart list holder with a small screen in accordance with the present invention;

### DETAILED DESCRIPTION

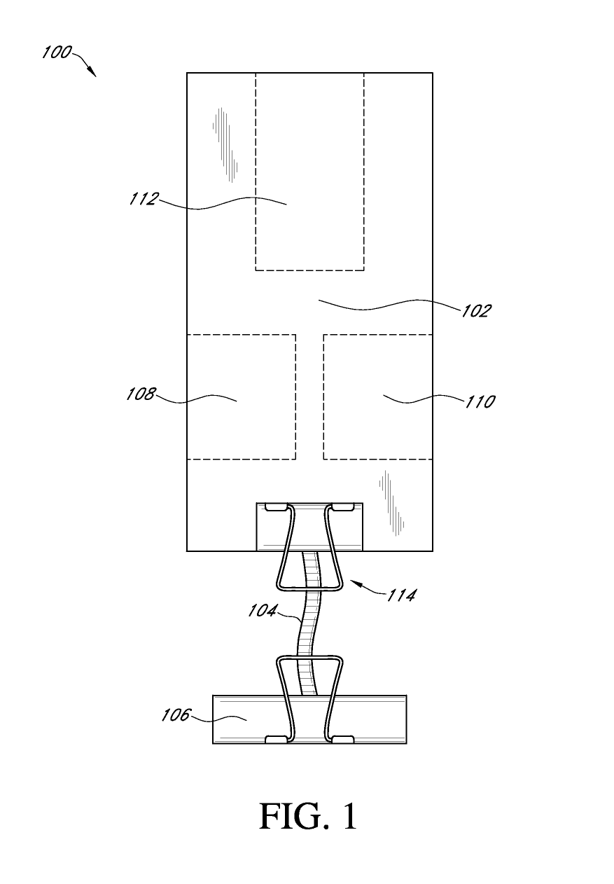

In accordance with an exemplary embodiment of the present invention, FIG. 1 illustrates a shopping cart list holder 100 capable of holding one or a few pieces of paper. In the present embodiment, the list holder has three principal sections: the central list backing support 102, the support neck 104, and the cart attachment 106. In an embodiment of the present invention the central list backing support 102 may be six inches long, three inches wide, and connect to a two-inch long flexible support neck 104.

The central list backing 102 support further contains means for holding the piece or pieces of paper in place. In the present embodiment, the means for holding is a set of three expandable flaps with one flap (108, 110) on opposing sides of the backing support and one expandable upper flap 112 at the top of the backing support 102. The present invention may use sets of magnets in the flaps (108, 110, 112) and in the backing support 102 to hold the flaps (108, 110, 112) to the backing support 102 to keep the shopping list in place. Alternatively or in addition to, the flaps (108, 110, 112) may be attached to the central backing support 102 in such a way that pressure is maintained on the shopping list that keeps it firmly in place. The present invention is by no means limited to these approaches. Other approaches may be taken to secure the piece or pieces of paper to the backing support 102. For example, the backing support 102 may include a translucent sleeve in which the piece or pieces of paper may be inserted. Furthermore, embodiments of the present invention may use any combination of clips, flaps, or adhesives in the design of the backing support 102 to secure the piece or pieces of paper. For instance, the number and size and design of the expandable support flaps may vary from embodiment to embodiment. A finger press list holder 114 is also used to secure a list to the central list support backing 102.

In an embodiment of the present invention, the backing support has only one flap on one side (and it may be placed on either side) that is positioned one inch from the bottom. The flap may be a plastic tension slide. The flap is flexible enough to allow for additional thickness such as a smart phone or tablet and tight enough to secure paper. It may be a double layer tension clip with a length of one half inch.

In an embodiment of the present invention, the support neck 104 connects the backing support 102 to the cart attachment 106. In FIG. 1, the support neck 104 is flexible and therefore allows the backing support 102 a certain range of movement when it is attached via the cart attachment 106 to either a shopping cart or shopping basket. In other embodiments the support neck 104 may be rigid or semi rigid and, thereby, hold the backing support 102 more firmly in place. The support neck 104 may be of varying lengths. Also, the support neck 104 may have an adjustable length. For instance, the support neck 104 may be attached to the backing support 102 or the cart attachment 106 via an auto-rewinding spool. This auto-rewinding spool would allow the user to select the length of the support neck 104.

In the embodiment of FIG. 1, the support neck 104 is made of a lightweight cord but the present invention is not so limited. In other embodiments, the support neck 104 may be made of any type of material in the form of a tape or ribbon capable of holding the backing support to the cart attachment.

The support neck 104 may be connected to the backing support 102 and the cart attachment 106 in a variety of ways. In an embodiment of the present invention, the support neck 104, backing support 102, and cart attachment 106 may all be made out of the same piece of material and, therefore, not require any additional means of connecting the three components. In other embodiments, the three components may be made out of different pieces of material and the support neck may be connected to the other components through the use of hinges or by using adhesives or staples or some other means capable of holding the list holder together under normal use and storage conditions.

The cart attachment 106 is responsible for securing the list holder 100 to the shopping cart or shopping basket. In the embodiment shown in FIG. 1, the cart attachment 106 is an openable and closable tube clamp sized to be able to fit snugly around the bars of a typical shopping cart or shopping basket. The clamp is designed to be operated by the user by pressing on the tube with his fingers. In the present embodiment, the clamp is coated with an agent that helps the clamp grip the bar and keep the list holder in place. The clamp's opening mechanism of the cart attachment is of such a resistance (that is, the ability to maintain its position or difficulty to be opened or closed) that it is easy enough for any user of a shopping cart to open and close but resistant enough that it does not accidentally open under normal use.

The cart attachment 106 may include a clamp of any shape or size capable of affixing the list holder 100 to the bar of a shopping cart or shopping basket. Furthermore, the cart attachment 106 may rely on hooks that are capable of attaching the list holder to a shopping cart or shopping basket. Also, the cart attachment 106 may rely on an adhesive that allows the list holder to be “taped” to the shopping cart or shopping basket. In an embodiment of the present invention, the clamp may be a finger clip that is pressed to open from a closed tension position and then let go to provide grip and tension with enough flexibility to allow for tight closure around the bar of any shopping cart or shopping basket.

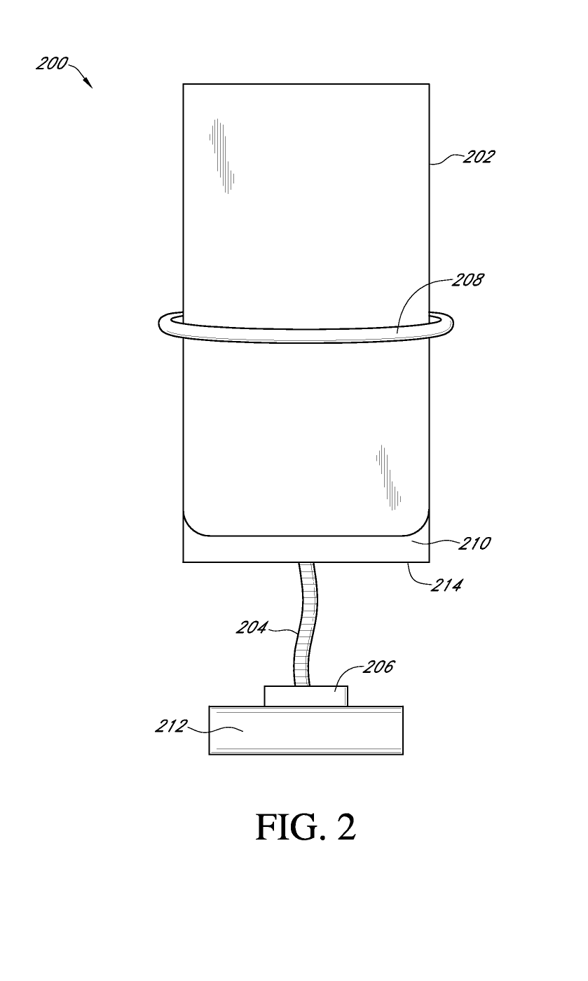

FIG. 2 illustrates a shopping cart list holder 200 further capable of holding a water bottle and a pen. In the present embodiment, the list holder 200 has three principal sections: the central list backing support 202, the support neck 204, and the cart attachment 206. The central list backing support 202 further contains means for holding the piece or pieces of paper in place. In the present embodiment, the means for holding is a set of three expandable flaps with one flap on opposing sides of the backing support and one expandable upper flap at the top of the backing support. The present invention is by no means so limited. Other approaches may be taken to secure the piece or pieces of paper to the backing support. For example, the backing support may include a translucent sleeve in which the piece or pieces of paper may be inserted. Furthermore, embodiments of the present invention may use any combination of clips, flaps, or adhesives in the design of the backing support to secure the piece or pieces of paper. For instance, the number and size and design of the expandable support flaps may vary from embodiment to embodiment.

The backing support 202 also includes means for holding a water bottle or handheld device, including but not limited to, a cell phone to the list holder 200. In the embodiment of FIG. 2, the means for holding a water bottle or handheld device is a flexible straps 208 that bind the water bottle or handheld device to the backing support 202. The strap 208 may be designed in a variety of ways. It may be a single expandable band which allows the user to slide the water bottle or handheld device between the band and the backing support and which has enough tension to keep the water bottle or handheld device in place. In another embodiment, the strap may include a Velcro connector which allows the user to adjust the tightness of the strap around the water bottle or handheld device to keep it securely in place. The holding means also may be a clip for holding the water bottle or cell phone to the list holder.

In the embodiment of FIG. 2, the backing support 202 also includes a pen holder 210. The pen holder 210 is located on the backing support 202 where the backing support 202 is attached to the support neck 204. In the present embodiment, the pen holder 210 is part of a clip used to secure the piece or pieces of paper to the backing support 202. The pen holder 210 may be made out of molded plastic that is an incomplete tube which is semi-rigid and allows the user to “snap” the pen into place by gently pushing the pen into place. The pen holder 210 may also use strap or straps to hold the pen into place. Furthermore, while the pen holder 210 is shown as being located near the connection of the backing support to the support neck, the present invention is by no means so limited. It may be located on either side of the backing support 202, away from the support neck 204 or on the other side of the backing support 202.

In an embodiment of the present invention, the support neck 204 connects the backing support to the cart attachment. In FIG. 2, the support neck 204 is flexible and therefore allows the backing support 202 a certain range of movement when it is attached via the cart attachment 206 to either a shopping cart or shopping basket. In other embodiments the support neck 204 may be rigid or semi rigid and, thereby, hold the backing support 202 more firmly in place. The support neck 204 may be of varying lengths. Also, the support neck 204 may have an adjustable length. For instance, the support neck 204 may be attached to the backing support 202 or the cart attachment 206 via an auto-rewinding spool. This auto-rewinding spool would allow the user to select the length of the support neck 204.

In the embodiment of FIG. 2, the support neck 204 is made of a lightweight cord but the present invention is not so limited. In other embodiments, the support neck 204 may be made of any type of material in the form of a tape or ribbon capable of holding the backing support 202 to the cart attachment 206.

The support neck 204 may be connected to the backing support 202 and the cart attachment 206 in a variety of ways. In an embodiment of the present invention, the support neck 204, backing support 202, and cart attachment 206 may all be made out of the same piece of material and, therefore, not require any additional means of connecting the three components. In other embodiments, the three components may be made out of different pieces of material and the support neck may be connected to the other components through the use of hinges or by using adhesives or staples or some other means capable of holding the list holder together under normal use and storage conditions.

The cart attachment 206 is responsible for securing the list holder 200 to the shopping cart or shopping basket. In the embodiment shown in FIG. 2, the cart attachment 206 is an openable and closable tube clamp 212 sized to be able to fit snugly around the bars of a typical shopping cart or shopping basket. The clamp 212 is designed to be operated by the user by pressing on the tube with his fingers. In the present embodiment, the clamp 212 is coated with an agent that helps the clamp grip the bar and keep the list holder 200 in place. The clamp's opening mechanism of the cart attachment 206 is of such a resistance (that is, the ability to maintain its position or difficulty to be opened or closed) that it is easy enough for any user of a shopping cart to open and close but resistant enough that it does not accidentally open under normal use.

The cart attachment 206 may include a clamp of any shape or size capable of affixing the list holder 200 to the bar of a shopping cart or shopping basket. Furthermore, the cart attachment 206 may rely on hooks that are capable of attaching the list holder 200 to a shopping cart or shopping basket. Also, the cart attachment 206 may rely on an adhesive that allows the list holder 200 to be “taped” to the shopping cart or shopping basket. In an embodiment of the present invention, the clamp may be a finger clip that is pressed to open from a closed tension position and then let go to provide grip and tension to hold item with enough flexibility within the tension to allow for tight closure around the bar of any shopping cart or shopping basket.

In an embodiment of the present invention, the cart attachment clamp 212 is two inches long with a radius that fits handle bar (normally about one inch in diameter). It may be made with flexible metal wire with a flexible protective rubber coating. The cart attachment clamp 212 may have a neck that is two inches long and a quarter inch wide. The neck may have a variety of designs. It may be circular or it may have a squared design.

The entire assembly of the list holder 200 is designed to weigh less than one pound. As mentioned before, a clamp 214 may be used to secure items to the backing support 202. In an embodiment of the present invention, the clamp 214 may include a chrome tension spring, chrome joint axle, or plastic hinges. The clamp 214 may include a plastic finger press for opening the clamp 214. Any clamp or other securing component on the list holder 200 may include a rubber coating to better secure its contents.

The shopping cart list holder may be made out of plastic, wood, or some other material suited to handle the wear-and-tear that the list holder might face. The list holder may also be decorated in some fashion. The list holder may be colored. For example, it may be either white or pink. The present invention is not so limited. It may be multicolored or decorated with patterns or writing or with logos. The decoration could be tied to the store or shopping center for which the list holder is used. Also, it may be an advertisement for any product or service. The list holder may be designed in such a way that decoration could be added to or replaced on the list holder.

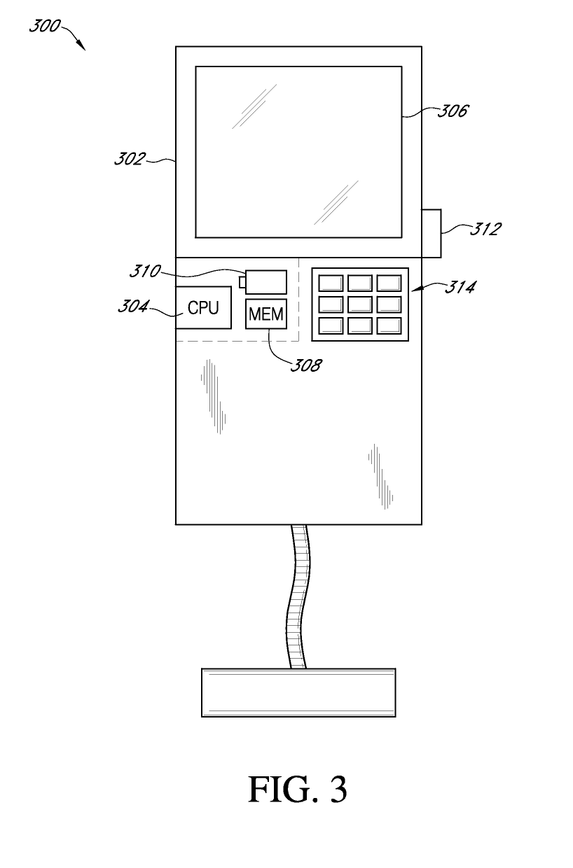

FIG. 3 shows an embodiment of the present invention where the list holder 300 also includes a digital device 302 that provides additional features for the customer. The digital device may include a microprocessor 304 along with a small screen 306 and memory 308 and a power supply 310. It may or may not include some kind of user input controls 314 to allow the user to interact with the electronic device. To load information onto the digital device, the device may include either a wireline connection such as a mini-USB connector or a wireless interface (such as WIFI or infra-red) 312. The digital device 302 may display uploaded user choices, the customer shopping list, or targeted choices or items on special. Furthermore, the retailer may also load programs to ease in navigation of the store. For instance, the retailer may load isle locations for items on the customer's. The screen 306 may also show digital advertising.

While several embodiments of the present invention have been illustrated and described herein, many changes can be made without departing from the spirit and scope of the invention. Accordingly, the scope of the invention is not limited by any disclosed embodiment.

The embodiments of the invention in which an exclusive property or privilege is claimed are defined as follows:

1. An apparatus comprising:
a central list backing support with at least one flap capable of holding a few sheets of paper to the central list backing support;
a support neck connected to the central list backing support; and
a cart attachment connected to the support neck;
wherein the apparatus is attachable to a shopping cart or shopping basket through the cart attachment.

2. The apparatus of claim 1 wherein the apparatus comprises three expandable flaps with one flap on opposing sides of the central list backing support and one expandable upper flap at the top of the central list backing support.

3. The apparatus of claim 2 wherein at least one of the flaps contains a magnet.

4. The apparatus of claim 1 wherein the support neck is of adjustable length.

5. The apparatus of claim 4 wherein the support neck comprises an auto-rewinding spool.

6. The apparatus of claim 1 wherein the cart attachment is an openable and closable tube clamp sized to be able to fit snugly around the bars of a typical shopping cart or shopping basket.

7. The apparatus of claim 6 wherein the cart attachment comprises a clamp is coated with an agent that helps the clamp grip the bar and keep the apparatus in place.

8. The apparatus of claim 1 wherein the central backing list support is about six inches long, three inches wide, and connects to an about two-inch long flexible support neck.

9. The apparatus of claim 1 further comprising a pen holder.

10. The apparatus of claim 1 wherein the support neck, central list backing support, and cart attachment are all be made out of the same piece of material.

11. The apparatus of claim 1 wherein the apparatus weighs less than a pound.

12. The apparatus of claim 1 further comprising a clamp to further secure paper to the central backing list support.

13. The apparatus of claim 1 further comprising one or more flexible straps that bind a water bottle or handheld device to the central backing list support.

14. The apparatus of claim 13 further comprising a single expandable band which allows a user to slide the water bottle or handheld device between the band and the central backing list support and has enough tension to keep the water bottle or handheld device in place.

15. The apparatus of claim 13 wherein the flexible strap is an adjustable Velcro connector for holding a water bottle or handheld device securely in place.

16. The apparatus of claim 1 wherein the central backing list support is made out of plastic.

17. The apparatus of claim 1 wherein the central backing list support further comprises a screen.
